(19) United States
(12) Patent Application Publication
(10) Pub. No.: US 2010/0201700 A1
(43) Pub. Date: Aug. 12, 2010

(54) DISPLAY APPARATUS, COMPUTER-READABLE RECORDING MEDIUM IN WHICH DISPLAY DATA DELETION PROGRAM IS RECORDED, AND DISPLAY DATA DELETION METHOD

(75) Inventors: Yoshihisa Kusumoto, Nagoya-shi (JP); Takuya Nagai, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/703,154

(22) Filed: Feb. 9, 2010

(30) Foreign Application Priority Data
Feb. 10, 2009 (JP) 2009-028724

(51) Int. Cl. G09G 5/36

(52) U.S. Cl. 345/545

(57) ABSTRACT

A display apparatus includes a display data obtaining device that obtains display data to be displayed in a display device, a storage control device that causes a storage device to store the obtained display data, a display control device that reads the display data from the storage device, and causes the display device to display the display data, and a deletion device that deletes the display data displayed in the display device among the display data stored in the storage device, from the storage device, in timing when it is determined that the display data has been displayed in the display device.

The entire disclosure of the Japanese Patent Application No. 2009-028724, including the specification, the scope of claims, drawings, and abstract, filed on Feb. 10, 2009 is incorporated herein by reference in its entirety.

### BACKGROUND OF THE INVENTION

1. Field of the Invention

The present invention relates to a display apparatus, a computer-readable recording medium in which a display data deletion program is recorded, and a display data deletion method, that deletes display data displayed in a display device, from a storage device,

2. Description of the Related Art

In recent year, there is a display apparatus configured to download contents data into a storage device such as a hard disk through a network, to obtain display data to be displayed in a display monitor successively from the hard disk or the like, and to cause the display monitor to display the display data.

For example, a technology concerning a method of sending documents while maintaining a document format in an electronic network is disclosed.

### SUMMARY OF THE INVENTION

In such a display apparatus, in the case where a user downloads contents data into a hard disk or the like to cause a display unit to display the contents data for the user's viewing, the contents data in the hard disk is not necessary after the user's a viewing. However, the contents data remains in the hard disc, as long as specific instructions of deletion are not provided, such as instructions of deletion based on the user's operation of an operation unit.

Particularly, if contents data is a highly confidential document, the above situation is not desirable from the viewpoint of security.

The present invention has been made in view of the above problem, and it is an object of the invention to provide a display apparatus, a computer-readable recording medium in which a display data deletion program is recorded, and a display data deletion method, with a high security.

In order to solve the above problem, one aspect of the invention relates to a display apparatus, comprising:

a display data obtaining device configured to obtain display data to be displayed in a display device;

a storage control device configured to cause a storage device to store the obtained display data;

a display control device configured to read the display data from the storage device, and to cause the display device to display the display data; and

a deletion device configured to delete the display data displayed in the display device among the display data stored in the storage device, from the storage device, in timing when it is determined that the display data has been displayed in the display device.

### BRIEF DESCRIPTION OF THE DRAWINGS

FIG. 1 is a block diagram showing an example of a schematic configuration of a portable display apparatus 1 according to the present embodiment;

FIG. 2 is a front view of a portable display apparatus 1 according to the present embodiment; and

FIG. 3 is a flow chart showing operations of processing performed by a CPU 101 of a portable display apparatus 1.

### DETAILED DESCRIPTION OF THE PREFERRED EMBODIMENT

An embodiment of the present invention will be described below with reference to the drawings.

The embodiment described below is an embodiment in which the present invention has been applied to a portable display apparatus 1.

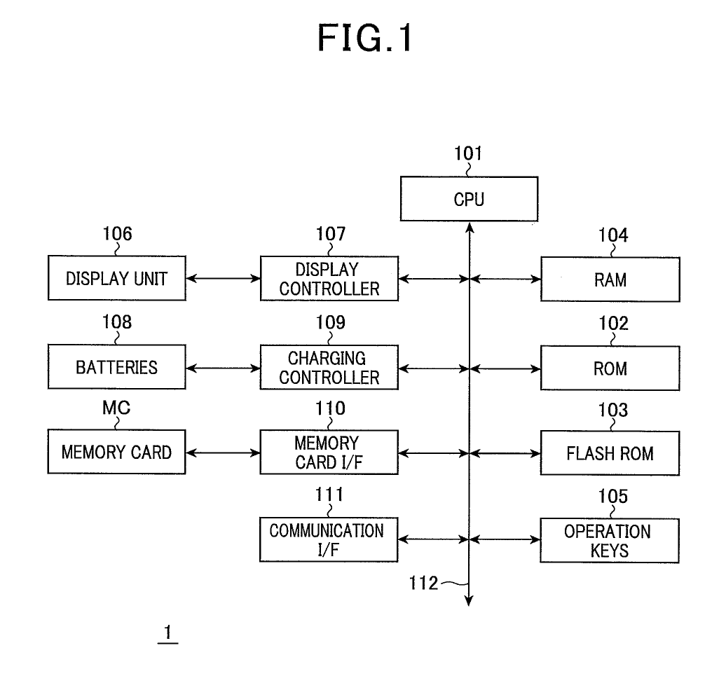

First, an outline of a configuration and an operation of a portable display apparatus 1 according to the present embodiment will be described with reference to FIG. 1.

As shown in FIG. 1, a portable display apparatus 1 includes a CPU (Central Processing Unit) 101 that centralized-controls the whole portable display apparatus 1, a ROM (Read Only Memory) 102 that stores firmware and the like, a flash ROM 103 that stores various control programs (including a display data deletion program according to the present invention), user settings, and the like, a RAM (Random Access Memory) 104 as an example of a volatile storage device that temporarily stores data necessary for control processing of the CPU 101 or contents data obtained from an external device or the like, operation keys 105 that are configured by a decision key 105a, an enlarging key 105b, a reducing key 105c, a page turning key such as a right key 105d and a left key 105e, and a power 105f, and supply instructions as an instructions receiving device from a user to the CPU 101 as instructions information, a display unit 106 that is configured by, for example, an electrophoretic image display panel or a liquid crystal display panel, and that displays contents constituted by one or a plurality of display data on a screen, and a display controller 107 that controls a display displayed by the display unit 106 based on instructions from the CPU 101.

The portable display apparatus 1 is also configured by batteries 108 constituted by, for example, lithium ion batteries, a charging controller 109 that controls charging of the batteries 108, and a memory card drive or the like, and includes a memory card I/F (interface) 110 that writes/reads data in/from a memory card MC inserted into the memory card drive based on instructions from the CPU 101, and a communication I/F 111 that performs an interface process to transmit/receive data by connecting the portable display apparatus 1, and an external device (external apparatus) such as a terminal device like a PDA, a server apparatus, and a personal computer (PC) to each other by wire or by radio.

The CPU 101, the ROM 102, the flash ROM 103, the RAM 104, the operation keys 105, the display controller 107, the charging controller 109, the memory card I/F 110, and the communication I/F 111 are mutually connected to each other via a bus 112.

The portable display apparatus 1 is configured in such a way that the CPU 101 functions as a display data obtaining device by the user's operation of the operation unit 105 to obtain desired contents data from a terminal device such as a PDA through a wire cable such as a USB cable or radio data communication, or from another server apparatus, a PC, or the like through a network, and to cause it to be displayed in the display unit 106.

More specifically, the CPU 101 downloads (temporarily stores) the obtained contents data into, for example, the RAM 104, and when the contents data is displayed, the CPU 101 and the display controller 101 access the RAM 104 to read the contents data to cause it to be displayed in the display unit 106.

Then, the displayed display data is deleted from the RAM 104.

(i) In the case where the contents data is constituted by only one display data

If the contents data is constituted by one display data, the CPU 101 deletes the displayed contents data (display data) from the RAM 104 in timing when it is determined that the contents data has been displayed in the display unit 106.

(ii) In the case where the contents data is constituted by a plurality of display data

If the contents data is constituted by a plurality of display data, the CPU 101 reads, display data to be displayed in the display unit 106, in a plurality of display data temporarily stored in the RAM 104 to cause the display unit 106 to display the display data.

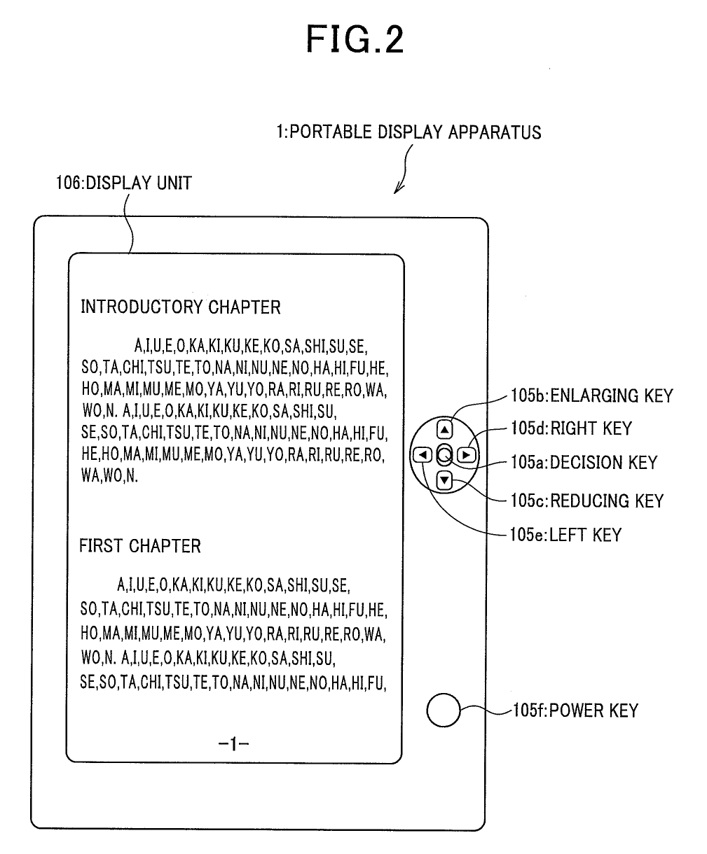

Here, “display data to be displayed in the display unit 106” is, for example, display data corresponding to an initial page in the case of a first display of contents. In an example shown in FIG. 2, a first page, which is an initial page of contents, is displayed in the display unit 106.

When various instructions such as turning pages by the user's operation of the operation unit 105 are received, display data corresponding to the next page (or the previous page) becomes to a display data to be displayed. Further, a page to be displayed may be arranged to be adequately selected by a user based on the user's operation of the operation unit 105.

If a page to be displayed corresponds to a plurality of display data, all corresponding display data becomes to “a display data to be displayed in the display unit 106”.

Then, the CPU 101 reads a display data to be displayed from the RAM 104, and deletes the display data (displayed display data) from the RAM 104 in timing when it is determined that the display data has been displayed in the display unit 106.

Thus, in the present embodiment, the displayed display data in display data temporarily stored in the RAM 104 is arranged to be deleted in timing when it is determined that the display data has been displayed. Accordingly, it becomes possible to prevent the deletion of display data from being forgotten, leading to enhanced security.

“Timing when it is determined that display data is displayed in the display unit 106” is, for example, timing when a display rewriting process is performed in the display unit 106 based on display data. Particularly, in the case where the display unit 106 is constructed by an electrophoretic image display panel, a cholesteric liquid crystal, or the like with high memory properties capable of maintaining the display state of images without power supply, an effect is achieved in that a user can continue to use (view) information displayed in the display unit 106, even if display data in the RAM 104 is instantly deleted, when a display rewriting process is performed in the display unit 106, because a display state once displayed in the display unit 106 can be maintained.

Timing when instructions to terminate a display of contents (hereinafter, referred to as “contents display termination instructions”), or image switching (rewriting) instructions such as page turning instructions are provided by the user's operation of the operation unit 105 may be also timing when it is determined that display data has been displayed in the display unit 106.

An arrangement may be as follows: when the contents display termination instructions are received or instructions to turn a power of the portable display apparatus 1 off (hereinafter, referred to as “power-off instructions”) are received, one or a plurality of display data stored in the RAM 104 are all deleted. Particularly when power-off instructions are received, and a power supply to the RAM 104 is stopped, display data stored in the RAM 104 can be deleted surely, and therefore, the enhanced effects in terms of security are achieved.

Incidentally, in the case where the display unit 106 is constructed to be able to maintain a display state as described above, the display unit 106 maintains the display state for a long time, even if display data in the RAM 104 is deleted, and this could become to disadvantages in terms of security. Therefore, the following arrangement is preferable: a display in the display unit 106 is terminated, and is refreshed in addition to the deletion of display data in RAM 104, when contents termination instructions or power-off instructions are received while display data is displayed in the display unit 106.

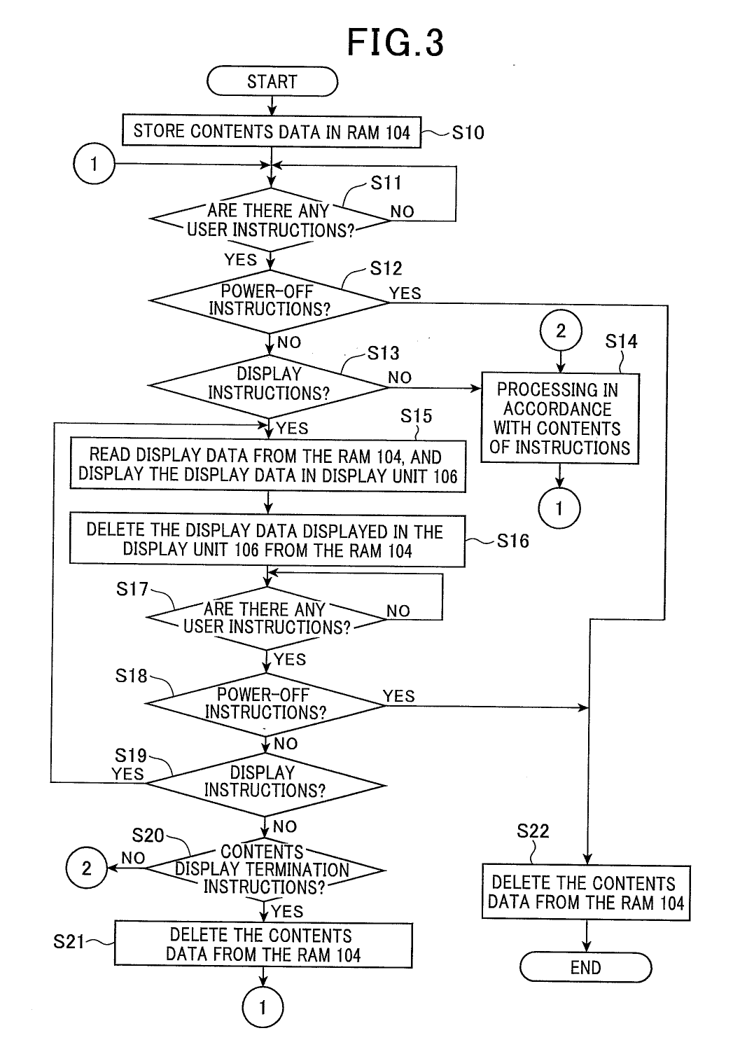

Now, operations of a portable display apparatus 1 will be described with reference to a flowchart shown in FIG. 3.

FIG. 3 is a flow chart showing operations of processing performed by a CPU 101 of a portable display apparatus 1, and after a power of the portable display apparatus 1 has been turned-on based on an operation of a power key 105f by a user, a display data deletion program is read from the flash ROM 103, and executed under the control of the CPU 101.

First, the CPU 101 functions as a display data obtaining device and a storage control device, and captures contents data from a terminal device such as PDA through a wire cable such as a USB cable or radio data communication or the like, or from another server apparatus or the like through a network, into the apparatus via the communication I/F 111, to store (download) the contents data in the RAM 104 (step S10).

Subsequently, the operation keys 105 are operated by a user, and it is determined whether any instructions have been provided (step S11). If no instructions are provided (step S11: No), a process at step S11 is repeated until any instructions are provided.

On the other hand, when instructions are provided by a user (step S11: Yes), it is determined whether the instructions are power-off instructions (step S12). If the instructions are not power-off instructions (step S12: No), it is determined whether a display of contents data stored in the RAM 104 is instructed (step S13).

As a result of the determination at step S13, if a display is not instructed (step S13: No), a process in accordance with contents of instructions instructed at step S11 is repeated (step S14), and a process moves to step S11.

On the other hand, if a display of contents data is instructed (step S13: Yes), the CPU 101 functions as a display control device, and reads, among a plurality of display data constituting contents data stored in the RAM 104, display data to be displayed in the display unit 106, from the RAM 104, and performs a display rewriting process in the display unit 106 based on the display data (step S15). At this time, the CPU 101 functions as a deletion device, and deletes the display data displayed in the display unit 106 at step S15 as displayed display data from the RAM 104 (step S16).

Subsequently, the operation keys 105 are operated by a user, and it is determined whether any instructions have been provided (step S17). If no instructions are provided (step S17: No), a process at step S17 is repeated until any instructions are provided.

In the case where the display unit 106 functions as a display device with memory properties capable of maintaining a display state, display data displayed in the display unit 106 at step S15 continues to be displayed in the display unit 106 while the displayed display data is deleted from the RAM 104 at step S16, and a process at step S17 is repeated.

Then, when instructions are provided by a user (step S17: Yes), it is determined whether the instructions are power-off instructions (step S18). If the instructions are not power-off instructions (step S18: No), it is determined whether a display of the next page (or another page) is instructed (step S19).

As a result of the determination, if the display is instructed (step S19: Yes), a process moves to step S15.

Then, if a display is not instructed (step S19: No), it is determined whether the termination of contents display has been instructed (step S20). If the termination of contents display is instructed (step S20: Yes), contents data (all display data) is deleted from the RAM 104 (step S21). When the display unit 106 functions as a display device with memory properties capable of maintaining a display state, a display of display data being displayed in the display unit 106 is terminated. Then, a process moves to step S11.

On the other hand, if power-off instructions have been provided in the determination at step S12 or step S18 (step S12: Yes or step S18: Yes), contents data, that is, all display data constituting the contents is deleted from the RAM 104 (step S22), and a process is terminated.

A display of display data being displayed in the display unit 106 is arranged to be terminated, if power-off instructions have been provided at step S18 (step S18: Yes), when the display unit 106 functions as a display device with memory properties capable of maintaining a display state.

According to a portable display apparatus 1 in the present embodiment, as described above, a display data whose display has been completed among display data temporarily stored in the RAM 104 is arranged to be deleted, and thus, a portable display apparatus 1 with a high security can be realized.

As described at steps S15 and S16, if display data in the RAM 104 is deleted immediately after a display process in the display unit 106 has been completed, the enhancement of security can be realized. Particularly, this is useful, when the display unit 106 is configured to be able to maintain a display state of images without receiving a power supply.

Further, when power-off instructions or contents display termination instructions are provided, all display data constituting contents stored in the RAM 104 are deleted, and thus, display data can be deleted reliably without much work.

A display is configured to be terminated, if power-off instructions or contents display termination instructions are provided during the display of display data in the display unit 106, when the display unit 106 is configured to be able to maintain a display state, so that a portable display apparatus 1 with more security can be provided.

In the above embodiment, the RAM 104 is caused to function as a storage device of the present invention to store display data, but the present invention is not limited to such a configuration, and a nonvolatile storage device (for example, a memory card MC, a ROM 102, or the like) may be caused to function as a storage device of the present invention. In such a case, all display data stored in the memory card MC or the ROM 102 is also arranged to be deleted, when contents display termination instructions or power-off instructions are received.

In the above embodiment, contents data temporarily stored in the RAM 104 is downloaded into the RAM 104 from another terminal device or the like into the RAM 104 through a network or the like, but the present invention is not limited to such a configuration, and, for example, contents data stored in a memory card MC may be arranged to be temporarily stored in the RAM 104.

The present invention is not confined to the configuration listed in the foregoing embodiments, but it is easily understood that the person skilled in the art can modify such configurations into various other modes, within the scope of the present invention described in the claims.

What is claimed is:

1. A display apparatus, comprising:
a display data obtaining device configured to obtain display data to be displayed in a display device;
a storage control device configured to cause a storage device to store the obtained display data;
a display control device configured to read the display data from the storage device, and to cause the display device to display the display data; and
a deletion device configured to delete the display data displayed in the display device among the display data stored in the storage device, from the storage device, in timing when it is determined that the display data has been displayed in the display device.

2. The display apparatus according to claim 1,
wherein the display device is a display device with memory properties capable of maintaining a display state of images without receiving power supply and
when a display rewriting process of the display data in the display device is performed by the display control device, the deletion device is configured to delete the display data displayed in the display device by the display rewriting process, from the storage device.

3. The display apparatus according to claim 1, further comprising:
an instructions receiving device configured to receive instructions, wherein the storage control device obtains contents constituted by a plurality of display data, and causes the storage device to store the contents,
when a display of the contents is instructed by the instructions receiving device, the display control device configured to cause the display device to display each of the display data constituting the contents, and
when a termination of the display of the contents is instructed by the instructions receiving device, the deletion device configured to delete a plurality of the display data constituting the contents, from the storage device.

4. The display apparatus according to claim 1, further comprising:
an instructions receiving device configured to receive instructions, wherein the storage device is a nonvolatile storage device and
when instructions to turn the display apparatus off are provided by the instructions receiving device, the deletion device is configured to delete all display data stored in the storage device, from the storage device.

5. The display apparatus according to claim 1, further comprising:
an instruction receiving device configured to receive instructions, wherein the storage device is a volatile storage device and
when instructions to turn the display apparatus off are provided by the instructions receiving device, the deletion device is configured to delete all display data stored in the storage device, from the storage device.

6. The display apparatus according to claim 4,
wherein in the case where the display device is a display device with memory properties capable of maintaining a display state of images without receiving power supply,
when instructions to turn the display apparatus off are provided by the instructions receiving device, the display control device is configured to terminate a display of the display data being displayed in the display device.

7. The display apparatus according to claim 5,
wherein in the case where the display device is a display device with memory properties capable of maintaining a display state of images without receiving power supply,
when instructions to turn the display apparatus off are provided by the instructions receiving device, the display control device is configured to terminate a display of the display data being displayed in the display device.

8. A computer-readable recording medium in which a display data deletion program is recorded,
the display data deletion program causing a computer to function as:
a display data obtaining device configured to obtain display data to be displayed in a display device;
a storage control device configured to cause a storage device to store the obtained display data;
a display control device configured to read the display data from the storage device, and to cause the display device to display the display data; and
a deletion device configured to delete the display data displayed in the display device among the display data stored in the storage device, from the storage device, in timing when it is determined that the display data has been displayed in the display device.

9. A display data deletion method, comprising:
a process of obtaining display data to be displayed in a display device;
a process of causing a storage device to store the obtained display data;
a process of reading the display data from the storage device, and causing the display device to display the display data; and
a process of deleting the display data displayed in the display device among the display data stored in the storage device, from the storage device, in timing when it is determined that the display data has been displayed in the display device.
